(19) United States
(12) Patent Application Publication
(10) Pub. No.: US 2025/0372654 A1
(43) Pub. Date: Dec. 4, 2025

(54) NEGATIVE ELECTRODE AND ELECTRICITY STORAGE DEVICE INCLUDING NEGATIVE ELECTRODE

(71) Applicant: Prime Planet Energy & Solutions, Inc., Tokyo (JP)

(72) Inventor: Shuhei TAKESHITA, Nagakute-shi (JP)

(21) Appl. No.: 19/220,088

(22) Filed: May 28, 2025

(30) Foreign Application Priority Data
Jun. 4, 2024 (JP) 2024-090589

(51) Int. Cl. H01M 4/62; H01M 4/02; H01M 4/133; H01M 4/134; H01M 4/38; H01M 4/587

(52) U.S. Cl. CPC H01M 4/622; H01M 4/133; H01M 4/134; H01M 4/386; H01M 4/587; H01M 2004/021; H01M 2004/027

(57) ABSTRACT

Provided is a technology that can suppress the capacity decrease after charge-discharge cycles in an electricity storage device containing silicon-containing graphite particles as a negative electrode active material. A negative electrode disclosed herein includes a negative electrode active material composed of silicon-containing graphite particles, a first binder, and a second binder. The silicon-containing graphite particles include graphite particles with voids and silicon-containing particles disposed in the voids. The first binder is styrene butadiene rubber with a glass-transition temperature of 1° C. or higher. The second binder is styrene butadiene rubber with a glass-transition temperature of lower than 1° C.

### CROSS REFERENCE TO RELATED APPLICATIONS

The present application claims the priority based on Japanese Patent Application No. 2024-090589 filed on Jun. 4, 2024, the entire contents of which are incorporated in the present specification by reference.

### BACKGROUND OF THE DISCLOSURE

### 1. Technical Field

The present disclosure relates to a negative electrode and an electricity storage device including the negative electrode.

### 2. Background

As an example of electricity storage devices, secondary batteries such as lithium-ion secondary batteries are mentioned. In recent years, this type of secondary battery has been suitably used in portable power sources for computers, mobile terminals, etc., as well as in power sources for driving vehicles such as electric vehicles (BEVs), hybrid electric vehicles (HEVs), and plug-in hybrid electric vehicles (PHEVs).

Japanese Patent Application Publication No. 2017-50142 discloses a negative electrode active material for lithium-ion secondary batteries. This negative electrode active material contains flake-like graphite particles and flake-like silicon particles with their surfaces coated with carbon. The flake-like graphite particles aggregate to form a particle shape. The silicon particles are present between the flake-like graphite particles. This publication states that such a configuration can provide a high-capacity and long-life negative electrode active material for lithium-ion secondary batteries.

Japanese Patent Application Publication No. 2023-156006 discloses a negative electrode for non-aqueous electrolyte secondary batteries. This negative electrode contains an active material layer. The active material layer contains graphite particles, fibrous carbon, silicon-containing particles, and a binder. The graphite particles have a BET specific surface area of 3.5 m²/g or less. The fibrous carbon contains carbon nanotubes. The silicon-containing particles contain a domain composed of carbon and a domain composed of silicon of 50 nm or less. The oxygen content in the silicon-containing particles is 7 wt % or less. This publication states that such a configuration can provide a negative electrode and a non-aqueous electrolyte secondary battery that suppress the decrease in initial capacity and the deterioration of cycle characteristics.

### SUMMARY

The inventor aims to suppress the capacity decrease after charge-discharge cycles in an electricity storage device containing silicon-containing graphite particles as the negative electrode active material.

According to the technology disclosed herein, a negative electrode is provided. The negative electrode includes a negative electrode active material composed of silicon-containing graphite particles, a first binder, and a second binder. The silicon-containing graphite particles include graphite particles with voids and silicon-containing particles disposed in the voids. The first binder is styrene butadiene rubber with a glass-transition temperature of 1° C. or higher. The second binder is styrene butadiene rubber with a glass-transition temperature of lower than 1° C. This configuration can suppress the capacity decrease after charge-discharge cycles in an electricity storage device containing silicon-containing graphite particles as the negative electrode active material.

### BRIEF DESCRIPTION OF THE DRAWINGS

FIG. 1 is a schematic cross-sectional view of a lithium-ion secondary battery 100.

FIG. 2 is a schematic diagram of an electrode assembly 20.

### DESCRIPTION OF THE EMBODIMENTS

Hereinafter, one embodiment of an electricity storage device disclosed herein will be described. The embodiment described herein is not intended to particularly limit the technology disclosed herein. The technology disclosed herein is not limited to the embodiment described herein, unless otherwise noted. The drawings are schematic and do not necessarily reflect actual products. Members and parts that have the same actions are appropriately denoted by the same symbols as appropriate, and a duplicate description thereof is omitted. The notation “A to B” indicating a numerical value range means “A or more and B or less” unless otherwise noted, and also encompasses the meaning of “above A and below B”.

In the present specification, the term “electricity storage device” refers to a device in which charging and discharging occur due to transfer of charge carriers between a pair of electrodes (a positive electrode and a negative electrode) via an electrolyte. The electricity storage devices encompass secondary batteries such as lithium-ion secondary batteries, capacitors such as lithium-ion capacitors and electrical double layer capacitors, and the like. The following describes the embodiment in which the electricity storage device is a lithium-ion secondary battery.

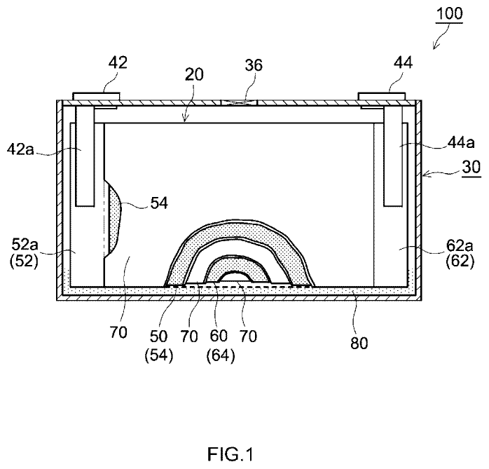

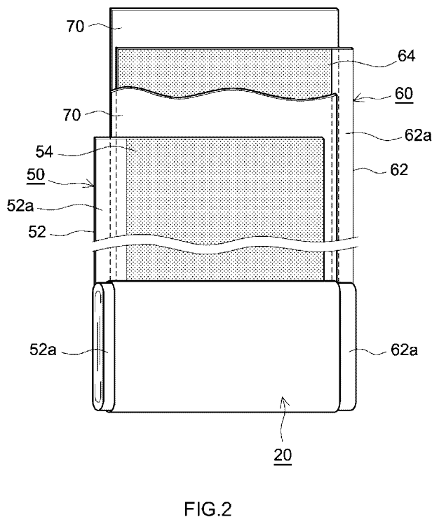

FIG. 1 is a schematic cross-sectional view of a lithium-ion secondary battery 100. FIG. 2 is a schematic diagram of an electrode assembly 20. As illustrated in FIG. 1, the lithium-ion secondary battery 100 includes the electrode assembly 20, a case 30, and a non-aqueous electrolyte solution 80.

As illustrated in FIGS. 1 and 2, the electrode assembly 20 is a wound electrode assembly in which a long sheet-shaped positive electrode 50 and a long sheet-shaped negative electrode 60 are overlapped each other with a long sheet-shaped separator 70 interposed between them, and these electrodes are wound in a sheet longitudinal direction (hereinafter also simply referred to as a “longitudinal direction”). In the electrode assembly 20, an exposed region 52a of the positive electrode 50 and an exposed region 62a of the negative electrode 60 extend off from respective ends in a transverse direction perpendicular to the longitudinal direction.

As illustrated in FIGS. 1 and 2, the positive electrode 50 has a long sheet-shaped positive electrode current collector 52 and a positive electrode active material layer 54. The positive electrode current collector 52 is, for example, an aluminum foil. In this embodiment, the positive electrode current collector 52 has a region where the positive electrode active material layer 54 is provided and the exposed region 52a where a surface of the positive electrode current collector 52 is exposed while the positive electrode active material layer 54 is not provided. The positive electrode active material layer 54 is provided in a band shape, for example, on one or both surfaces (here, both surfaces) of the positive electrode current collector 52 along the longitudinal direction. The positive electrode active material layer 54 is not provided at an end portion (left end portion in the figure) of the positive electrode current collector 52 in the sheet transverse direction (hereinafter also simply referred to as the “transverse direction”). The exposed region 52a here is a band-shaped region at the end portion (left end portion in the figure) of the positive electrode current collector 52 in the transverse direction. As illustrated in FIG. 1, a current collector plate 42a is attached to the exposed region 52a.

The positive electrode active material layer 54 contains, for example, a positive electrode active material. The positive electrode active material is not particularly limited as long as it exhibits the effects of the technology disclosed herein. Any positive electrode active materials having conventionally known compositions usable for this type of application may also be used. The positive electrode active material is desirably, for example, a lithium composite oxide, a lithium transition metal phosphate compound, or the like. The crystal structure of the positive electrode active material is not particularly limited and may be a layered, spinel, olivine, or another type of structure.

As a lithium composite oxide, lithium transition metal composite oxides containing at least one of Ni, Co, or Mn as a transition metal element are preferable. Examples of lithium transition metal composite oxides include lithium nickel-based composite oxides, lithium cobalt-based composite oxides, lithium manganese-based composite oxides, lithium nickel manganese-based composite oxides, lithium nickel cobalt manganese-based composite oxides, lithium nickel cobalt aluminum-based composite oxides, lithium iron nickel manganese-based composite oxides, and the like. These positive electrode active materials may be used alone or in combination of two or more kinds.

The term “lithium nickel cobalt manganese-based composite oxide” as used in the present specification is a term that encompasses oxides containing Li, Ni, Co, Mn, and O as constituent elements, as well as oxides that contain one or more additive elements in addition to these constituent elements. Examples of the additive elements include transition metal elements such as Mg, Ca, Al, Ti, V, Cr, Y, Zr, Nb, Mo, Hf, Ta, W, Na, Fe, Zn, and Sn, and typical metal elements. Alternatively, examples of the additive elements may also include: semi-metallic elements such as B, C, Si, and P; and non-metallic elements such as S, F, Cl, Br, and I. This can also be applied for the lithium nickel-based composite oxides, lithium cobalt-based composite oxides, lithium manganese-based composite oxides, lithium nickel manganese-based composite oxides, lithium nickel cobalt aluminum-based composite oxides, lithium iron nickel manganese-based composite oxides, and the like.

Examples of lithium transition metal phosphate compounds include lithium iron phosphate (LiFePO₄), lithium manganese phosphate (LiMnPO₄), lithium iron manganese phosphate, and the like. Examples of the positive electrode active material preferably used include LiNi_{0.33}Co_{0.33}Mn_{0.33}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂, LiNiO₂, LiCoO₂, LiFeO₂, LiMn₂O₄, LiNi_{0.5}Mn_{1.5}O₄, and the like.

In addition to the positive electrode active material, the positive electrode active material layer 54 may contain a conductive material, a binder, and the like. Examples of the conductive material include carbon black such as acetylene black (AB); and other carbon materials such as graphite. Examples of the binder include polyvinylidene fluoride (PVDF) and the like. The content of the positive electrode active material in the entire positive electrode active material layer 54 is, for example, preferably 70 mass % or more, more preferably 80 mass % to 98 mass %, and even more preferably 85 mass % to 95 mass %. The content of the conductive material in the entire positive electrode active material layer 54 is, for example, 0.1 mass % to 20 mass %. The content of the binder in the entire positive electrode active material layer 54 is, for example, 0.5 mass % to 15 mass %.

As illustrated in FIGS. 1 and 2, the negative electrode 60 includes a long sheet-shaped negative electrode current collector 62 and a negative electrode active material layer 64. The negative electrode current collector 62 is, for example, a copper foil. In this embodiment, the negative electrode current collector 62 has a region where the negative electrode active material layer 64 is provided and the exposed region 62a where a surface of the negative electrode active material layer 64 is exposed while the negative electrode active material layer 64 is not provided. The negative electrode active material layer 64 is provided in a band shape, for example, on one or both surfaces (here, both surfaces) of the negative electrode current collector 62 along the longitudinal direction. The negative electrode active material layer 64 is not provided at an end portion (right end portion in the figure) of the negative electrode current collector 62 in the transverse direction. The exposed region 62a here is a band-shaped region at the end portion (right end portion in the figure) of the negative electrode current collector 62 in the transverse direction. As illustrated in FIG. 1, a current collector plate 44a is attached to the exposed region 62a.

The negative electrode active material layer 64 contains, for example, a negative electrode active material. In this embodiment, the negative electrode active material includes silicon-containing graphite particles. The silicon-containing graphite particles include, for example, graphite particles with voids and silicon-containing particles disposed in the voids. The graphite particles with voids can serve as base particles of the silicon-containing particles. Although not particularly limited, from the viewpoint of including more silicon-containing particles to achieve higher capacity, higher energy density, and the like of the lithium-ion secondary battery 100, it is preferred that the graphite particles with voids are porous graphite particles. Alternatively, in other embodiments, the graphite particles with voids may be agglomerates of flake-like graphite particles.

The silicon-containing graphite particles have an average particle diameter of approximately 0.1 μm to 20 μm. From the viewpoint of exhibiting the effects of the technology disclosed herein, the average particle diameter is, for example, 0.3 μm or more, preferably 0.5 μm or more, more preferably 1 μm or more, and even more preferably 2 μm or more. From the viewpoint of enhancing the degree of filling in the negative electrode active material layer 64, the average particle diameter is, for example, 15 μm or less, preferably 10 μm or less, and more preferably 5 μm or less. In the present specification, “average particle diameter” regarding particles means the particle diameter corresponding to the cumulative 50% value from the fine particle side (D₅₀ particle diameter) in the volume-based particle size distribution, as measured by particle size distribution measurement based on a laser diffraction and light scattering method. Note that the average particle diameter of silicon-containing graphite particles may be equivalent to, for example, the average particle diameter of the graphite particles with voids described above.

Silicon-containing particles included in the silicon-containing graphite particles may be, for example, any particles that contain silicon and function as the negative electrode active material. The silicon-containing particles may be, for example, silicon particles or silicon oxide particles. In this embodiment, the silicon-containing particles have a particle diameter of 1 μm or less. Although not particularly limited, from the viewpoint of allowing graphite particles to contain more silicon-containing particles inside (e.g., within the voids of the graphite particles), the particle diameter of the silicon-containing particles is generally 500 nm or less, for example, 250 nm or less, preferably 150 nm or less, more preferably 100 nm or less, and even more preferably 50 nm or less. From the same viewpoint, the silicon-containing particles have a particle diameter of, for example, 1 nm or more, preferably 3 nm or more, more preferably 5 nm or more, and even more preferably 10 nm or more. The particle diameter of the silicon-containing particles is determined, for example, by obtaining an SEM observation image through observation of a plane surface of silicon-containing particles with an electron microscope (SEM), randomly selecting multiple (e.g., 10 to 100) silicon-containing particles from the SEM observation image, measuring the particle diameters (circular equivalent diameters) of the respective particles, and calculating an arithmetic mean value of them. Alternatively, the nominal value specified by manufacturers or the like may be adopted.

The silicon-containing graphite particles can be obtained according to known methods. For example, they can be obtained by mixing silicon-containing particles with carbon precursors (e.g., petroleum pitch, coal pitch, phenol resin, etc.), followed by carbonization and spheronization treatment on the mixture. Alternatively, they can be obtained by mixing a spherically granulated graphite base material and silicon-containing particles in a dispersant, drying the mixture, and disposing the silicon-containing particles in voids of the graphite particles as the base material.

In this embodiment, the negative electrode active material further contains other graphite particles that are different from the silicon-containing graphite particles (hereinafter also simply referred to as “other graphite particles”). The other graphite particles are, for example, graphite particles substantially free of silicon (preferably graphite particles that do not contain silicon). Regarding the other graphite particles, “substantially free of silicon” means that the silicon content in the other graphite particles is 1 mass % or less, preferably 0.5 mass % or less, and more preferably 0.3 mass % or less. Such a silicon content can be calculated, for example, by conventionally known methods such as ICP analysis. The other graphite particles may be made of, for example, artificial graphite, natural graphite, and the like. The other graphite particles may have a coating layer of amorphous carbon on the surface thereof. Although not particularly limited, the other graphite particles each have, for example, a substantially spherical shape. In the present specification, regarding the other graphite particles, “substantially spherical shape” means that the average aspect ratio of the other graphite particles based on SEM observation is 1 to 2 (preferably 1 to 1.5). The average aspect ratio is determined, for example, by obtaining a planar SEM observation image of other graphite particles, randomly selecting multiple (e.g., 10 to 100) graphite particles from the SEM observation image, calculating their respective aspect ratios, and then calculating an arithmetic mean value of them. The average particle diameter of the other graphite particles is desirably, for example, 5 μm to 30 μm, or may be 15 μm to 25 μm.

Although not particularly limited, from the viewpoint of achieving higher capacity and higher energy density of the lithium-ion secondary battery 100, when the total amount of silicon-containing graphite particles and graphite particles is set to 100 mass %, the negative electrode active material layer 64 desirably contains, for example, 0.3 mass % or more of the silicon-containing graphite particles, preferably 0.5 mass % or more, more preferably 1 mass % or more, and even more preferably 1.5 mass % or more. On the other hand, from the viewpoint of suppressing expansion and contraction of the negative electrode 60 due to its charging and discharging, when the total amount of silicon-containing graphite particles and graphite particles is set to 100 mass %, the negative electrode active material layer 64 desirably contains generally 20 mass % or less of the silicon-containing graphite particles, for example, 10 mass % or less, preferably 7.5 mass % or less, or more preferably 5 mass % or less.

In addition to the negative electrode active material, the negative electrode active material layer 64 may contain a conductive material. Examples of suitable conductive materials include: carbon black such as acetylene black (AB); carbon nanotubes such as single-walled carbon nanotubes (SWCNT), double-walled carbon nanotubes (DWCNT), and multi-walled carbon nanotubes (MWCNT); carbon fiber; and the like.

The proportion of the negative electrode active material in the entire negative electrode active material layer 64 is, for example, 70 mass % or more, preferably 80 mass % or more, and more preferably 85 mass % to 99 mass %, and may be 90 mass % to 95 mass %. The proportion of the conductive material in the entire negative electrode active material layer 64 may be, for example, 0.01 mass % to 3 mass %.

In this embodiment, the negative electrode active material layer 64 contains a binder. The binder has the function of, for example, causing particles of the negative electrode active material to adhere to each other and retaining the negative electrode active material on the surface of the negative electrode current collector 62. As described above, when silicon-containing graphite particles including graphite particles with voids are used as the negative electrode active material, for example, there is a concern that the binder may penetrate into the voids of the silicon-containing graphite particles, thereby suppressing the function of the binder. Thus, ingenuity has been required to fully achieve the function of the binder. In light of this, the inventors have studied the types of binders that can be used in the negative electrode active material layer 64. The term “binder” in the following description is used to generally refer to the binder as a whole contained in the negative electrode active material layer 64.

The negative electrode active material layer 64 includes a first binder and a second binder. The first binder is, for example, styrene butadiene rubber (SBR) with a glass-transition temperature of 1° C. or higher. The first binder has, for example, a linkage structure in which first binder particles are linked in a chain. The linkage structure can be confirmed, for example, by observing a cross-section of the negative electrode active material layer 64 with the SEM. Thus, the first binder is less likely to penetrate into the voids of the silicon-containing graphite particles, for example, and it can link the particles of the negative electrode active material over a wider area. From the viewpoint of linking more particles of the negative electrode active material over a wider area, the glass-transition temperature of the first binder is preferably 3° C. or higher, and more preferably 5° C. or higher. From the same viewpoint, the glass-transition temperature of the first binder is generally 30° C. or lower, for example, 20° C. or lower, preferably 15° C. or lower, more preferably 12° C. or lower, and even more preferably 10° C. or lower.

The second binder is, for example, SBR with a glass-transition temperature of lower than 1° C. The second binder includes, for example, granular second binder particles. The second binder particles here are not linked to each other and do not present a linkage structure. The shape and the form of existence of the second binder can be confirmed, for example, by observing a cross-section of the negative electrode active material layer 64 with the SEM. The second binder has the function of, for example, enhancing adhesion between the particles of the negative electrode active material. From the viewpoint of enhancing adhesion between the particles of the negative electrode active material, the glass-transition temperature of the second binder is preferably 0.7° C. or lower, and more preferably 0.5° C. or lower. From the same viewpoint, the glass-transition temperature of the second binder is generally −40° C. or higher or −30° C. or higher, for example, −20° C. or higher, or −10° C. or higher, preferably −7° C. or higher, more preferably −5° C. or higher, and even more preferably −3° C. or higher.

Although not particularly limited, from the viewpoint of better achieving the effects of the technology disclosed herein, it is desirable that the difference in the glass-transition temperature between the first binder and the second binder is generally 2° C. or higher. The difference in the glass-transition temperature between the first binder and the second binder is, for example, 3° C. or higher, preferably 5° C. or higher, and more preferably 7° C. or higher.

From the same viewpoint, the difference in the glass-transition temperature between the first binder and the second binder is generally 40° C. or lower, or 30° C. or lower, for example, 20° C. or lower, or 17° C. or lower, preferably 15° C. or lower, more preferably 13° C. or lower, and even more preferably 10° C. or lower.

For example, the content of the first binder in the negative electrode active material layer 64 may be the same, smaller than, or larger than the content of the second binder therein. Regarding the contents (mass ratio) of the first binder and the second binder in the negative electrode active material layer 64, the ratio (first binder:second binder) is, for example, 10:90 to 90:10, and preferably 30:70 to 90:10. Although not particularly limited, from the viewpoint of better achieving the effects of the technology disclosed herein, the content of the first binder in the negative electrode active material layer 64 is preferably greater than or equal to the content of the second binder. In this case, the ratio (first binder:second binder) is preferably 50:50 to 90:10.

In this embodiment, the negative electrode active material layer 64 contains a third binder, in addition to the first and second binders. Examples of the third binder includes carboxymethyl cellulose (CMC), polyacrylic acid (PAA), SBR, polyvinylidene fluoride (PVDF), and the like. Among these, carboxymethyl cellulose (CMC) can be preferably used as the third binder. Note that SBR, which is the third binder, is here SBR that does not fall under either the first binder or the second binder.

When the total amount of the binders in the negative electrode active material layer 64 is set to 100 mass %, the total content of the first binder and the second binder is generally 30 mass % to 100 mass %. From the viewpoint of improving the productivity of the negative electrode active material layer 64, in turn, the negative electrode 60, the lithium-ion secondary battery 100, and the like, when the total amount of the binders in the negative electrode active material layer 64 is set to 100 mass %, the total content of the first binder and the second binder is, for example, 40 mass % to 90 mass %, preferably 50 mass % to 80 mass %, more preferably 50 mass % to 70 mass %, and even more preferably 55 mass % to 65 mass %. The proportion of the total amount of the binders is desirably 0.5 mass % to 10 mass %, for example, when the total amount of the negative electrode active material layer 64 is set to 100 mass %.

The separator 70 is, for example, a porous sheet (film) made of resin material such as polyethylene (PE), polypropylene (PP), polyester, cellulose, or polyamide. The porous sheet may have a single-layer structure or a laminated structure of two or more layers (e.g., a three-layer structure having a PP layer on both sides of a PE layer). A heat resistant layer (HRL) may be provided on the surface of the separator 70.

The case 30 is, for example, an outer container that houses therein the electrode assembly 20 and the non-aqueous electrolyte solution 80. The case 30 here is a flat, rectangular case. As illustrated in FIG. 1, the case 30 has a positive electrode terminal 42, a negative electrode terminal 44, a safety valve 36, and a pouring hole (not illustrated). The positive electrode terminal 42 is, for example, an external connection terminal on the positive electrode side. The positive electrode terminal 42 here is electrically connected to the positive electrode 50 of the electrode assembly 20 via the current collector plate 42a. The negative electrode terminal 44 is, for example, an external connection terminal on the negative electrode side. The negative electrode terminal 44 here is electrically connected to the negative electrode 60 of the electrode assembly 20 via the current collector plate 44a. The safety valve 36 is, for example, a thin-walled part set to release the internal pressure of the case 30 when it increases to a predetermined level or higher. The pouring hole is, for example, a port through which the non-aqueous electrolyte solution 80 is poured into the case 30.

The non-aqueous electrolyte solution 80 contains, for example, a non-aqueous solvent and a supporting salt. Examples of non-aqueous solvents used in this type of application include various organic solvents such as carbonates, ethers, esters, nitriles, sulfones, and lactones. Among these, carbonates are preferably usable. Examples of carbonates include ethylene carbonate (EC), propylene carbonate (PC), diethyl carbonate (DEC), dimethyl carbonate (DMC), ethyl methyl carbonate (EMC), fluoroethylene carbonate (FEC) (preferably, monofluoroethylene carbonate), monofluoromethyl difluoromethyl carbonate (F-DMC), trifluorodimethyl carbonate (TFDMC), and the like. As the non-aqueous solvent, the non-aqueous solvents may be used alone or in combination with two or more kinds. Examples of supporting salts include lithium salts such as LiPF₆, LiBF₄, and LiClO₄. The concentration of the supporting salt may be, for example, 0.7 mol/L to 1.4 mol/L. The non-aqueous electrolyte solution 80 may contain an additive that can be used in this type of application, if necessary. Examples of additives may include film-forming agents such as LiB(C₂O₄)₂ (LiBOB) and LiBF₂(C₂O₄); gas generating agents such as biphenyl (BP) and cyclohexylbenzene (CHB); thickening agents; and the like.

The lithium-ion secondary battery 100 can be used for various applications. Suitable applications include drive power sources mounted on vehicles, such as electric vehicles (BEVs), hybrid electric vehicles (HEVs), and plug-in hybrid electric vehicles (PHEVs). The lithium-ion secondary battery 100 can be used as a storage battery, for example, in a compact power storage device. The lithium-ion secondary battery 100 can be used, for example, in the form of a battery pack in which multiple batteries are connected in series and/or in parallel.

As described above, the negative electrode 60 includes the negative electrode active material, which is composed of silicon-containing graphite particles, the first binder, and the second binder. The silicon-containing graphite particles contain silicon and graphite, and include graphite particles with voids and silicon-containing particles disposed in the voids. The first binder is SBR with a glass-transition temperature of 1° C. or higher. The second binder is SBR with a glass-transition temperature of lower than 1° C.

By including silicon-containing graphite particles as the negative electrode active material, the negative electrode 60 can achieve high capacity and high energy density. The silicon-containing graphite particles include graphite particles with voids and silicon-containing particles disposed in the voids. This allows the voids to mitigate the expansion and contraction of the silicon-containing particles due to charging and discharging, thereby suppressing the expansion and contraction of the negative electrode 60. The negative electrode 60 includes the first binder with a glass-transition temperature of 1° C. or higher. For example, the first binder is less likely to penetrate into the voids of the silicon-containing graphite particles. Thus, in the negative electrode 60, for example, the first binder can link the particles of the negative electrode active material over a wider area and can suppress the deterioration of the function of the binder and the inhibition of a conductive path in the silicon-containing graphite particles, due to the penetration of the binder into the voids. The negative electrode 60 contains the second binder with a glass-transition temperature of lower than 1° C. In the negative electrode 60, the second binder can enhance adhesion between the particles of the negative electrode active material. By including both the first binder and the second binder, which have mutually different glass-transition temperatures, the negative electrode 60 can link more particles of the negative electrode active material over a wider area with higher adhesion, and can also enhance the adhesion between the negative electrode active material layer 64 and the negative electrode current collector 62. This can suppress the capacity decrease of the electricity storage device (here, the lithium-ion secondary battery 100) including the negative electrode 60 after charge-discharge cycles.

The difference in the glass-transition temperature between the first binder and the second binder may be 5° C. or higher. Thus, the respective functions of the first binder and the second binder can be achieved more efficiently. This allows the effects of the technology disclosed herein to be better achieved.

The negative electrode 60 may contain the first binder more than the second binder. This can more effectively reduce the amount of the binders penetrating into the voids of the silicon-containing graphite particles. Thus, the effects of the technology disclosed herein can be further enhanced.

The silicon-containing particles may have a particle diameter of 1 μm or less. This can achieve high output while improving the conductivity in the negative electrode active material.

The negative electrode 60 may further contain graphite particles that are substantially free of silicon as the other negative electrode active material. This can improve the conductivity of the negative electrode active material layer 64.

In addition to the negative electrode 60 described above, the technology disclosed herein also discloses the lithium-ion secondary battery 100. The lithium-ion secondary battery 100 includes the negative electrode 60. In the lithium-ion secondary battery 100, the capacity decrease after charge-discharge cycles is suppressed by including the negative electrode 60.

The following is a description of test examples related to the technology disclosed herein, but it is not intended to limit the technology disclosed herein to that illustrated in the following test examples.

### [Production of Test Cells]

### Examples 1 to 4 and Comparative Examples 1 to 3

LiNi_{1/3}Co_{1/3}Mn_{1/3}O₂ (LNCM) as the positive electrode active material, acetylene black (AB) as the conductive material, and polyvinylidene fluoride (PVdF) as the binder were prepared. These were combined with N-methylpyrrolidone (NMP) as a solvent at a mass ratio of LNCM:AB:PVdF=92:5:3 and kneaded together using a stir granulator to fabricate a positive electrode slurry. The positive electrode slurry was applied to both surfaces of an aluminum foil of 15 μm in thickness, dried, pressed to a predetermined thickness, and then processed to have predetermined dimensions, thereby producing a positive electrode.

Graphite particles (graphite particles substantially free of silicon) and silicon-containing graphite particles were prepared as the negative electrode active material. The graphite particles had an average particle diameter of 22 μm and a BET specific surface area of 1.4 m²/g. The silicon-containing graphite particles included graphite particles having an average particle diameter of 3 μm and including voids and silicon particles disposed in the voids. The silicon particles had a particle diameter of 30 nm. Acetylene black (AB) was prepared as the conductive material. Carboxymethyl cellulose (CMC) and styrene butadiene rubber (SBR) were prepared as the binders. Among these, as the SBR, SBRa, which has a glass-transition temperature of 8 degrees, SBRB, which has a glass-transition temperature of 0 degree, and SBRγ, which has a glass-transition temperature of −10 degrees, were prepared. A negative electrode slurry with a mass ratio of graphite particles/silicon-containing graphite particles/AB/CMC/SBR=93:2:1:1:3 was prepared. The composition ratio of SBR in each example was set as illustrated in the corresponding column of Table 1. A kneading machine used for the following kneading and mixing was a “HIVIS MIX MODEL 2P-1”, manufactured by PRIMIX Corporation.

In preparing the negative electrode slurry, graphite particles, silicon-containing graphite particles, AB, and CMC were first kneaded at a rotation speed of 30 rpm to obtain a first mixture. Then, water was added to the first mixture and kneaded together at a rotation speed of 50 rpm to obtain a second mixture. The second mixture was then mixed with SBR and water to obtain the negative electrode slurry. The negative electrode slurry was then applied to both surfaces of a copper foil of 10 μm in thickness, dried, pressed to a predetermined thickness, and processed to have predetermined dimensions, thereby producing a negative electrode. The area weight of the negative electrode slurry was 215 g/m² on each surface. The packing density was 1.6 g/cc. The packing density Z is calculated by using the following equation (P):

$$Packing density Z ( g / cc ) = \cdot \{ Area weight X of active material layer ( g / {m}^{2} ) / \{ Thickness Y of active material layer ( μ m ) \} . \qquad ( P )$$

As a separator, a porous polyolefin sheet (20 μm thickness) having a three-layer structure of PP/PE/PP, onto which a heat-resistant layer (4 μm thickness) was provided, was prepared. A lead was attached to each of the positive electrode and the negative electrode, and these respective electrodes were stacked with a separator therebetween to fabricate an electrode assembly. The electrode assembly was inserted into an outer body of an aluminum laminate sheet, filled with a non-aqueous electrolyte solution, and the opening of the outer body was sealed to fabricate a test cell of each example. The composition (volume ratio) of the non-aqueous electrolyte solution was EC/FEC/EMC/DMC=15:5:40:40. In this non-aqueous electrolyte solution, LiPF₆ as the supporting salt was dissolved at a concentration of 1 mol/L.

### [Peel Strength Test]

A 90-degree peel strength test, measured in accordance with JIS C6481 (1996), was conducted. Specifically, a test method for measuring peel strength (90-degree peel strength) was conducted. In more detail, first, the prepared negative electrode was cut to a predetermined size, and a rectangular test piece was prepared. One surface of the test piece was fixed onto a base of a tensile tester by using an adhesive such as double-sided tape. Further, a tape was applied to the other surface of the test piece, with the end of the tape fixed to a tensile jig. The tensile jig was then pulled upward at a predetermined speed (e.g., 0.5 mm per second) in the vertical direction (at a peeling angle of 90±5°) relative to the surface of the base (here, the negative electrode attached onto the base), and the negative electrode active material layer adhered to the tape was peeled off from the copper foil. At this time, an average value of the loads during the peeling of the negative electrode active material layer from the copper foil was measured, and an average value of the loads per unit width was defined as a peeling strength (N/mm). The results are illustrated in the corresponding columns of Table 1. The peel strength illustrated in Table 1 was a relative value when the peel strength of Example 1 was set to 100. Here, examples in which a peel strength was 70 or higher are evaluated as having sufficiently high peel strength.

### [Measurement of Initial Capacity]

The test cells were charged at a constant current (CC charged) at a charge rate of 0.05 C until the voltage between the positive electrode and the negative electrode reached 4.2V, and then discharged at a constant current (CC discharged) at a discharge rate of 0.05 C until the voltage between the positive electrode and the negative electrode reached 2.5V, under an environment of 25° C. This charge-discharge process conducted was defined as one cycle. The discharge capacity at this time was measured and defined as the initial capacity.

### [Evaluation of Cycle Characteristics]

The test cell was CC charged at 0.33 C to 4.14V in a thermostatic chamber at 25° C., then CV charged until the current value reached 0.1 C, achieving a fully charged state. It was then CC discharged at 0.33 C until it reached 3V. This charge-discharge process was defined as one cycle, and was repeatedly conducted for 200 cycles. The capacity retention rate of the test cell in each example after 200 cycles was calculated based on the following equation (X):

$$Capacity retention rate ( \% ) = ( Discharge capacity after 200 cycles / Initial capacity ) \times 100. \qquad ( X )$$

The results are shown in the corresponding columns of Table 1. Here, it was evaluated that the capacity decrease after the charge-discharge cycles was suppressed in the example with a capacity retention rate of 65% or more.

TABLE 1

| | | | | | Capacity |
|---|---|---|---|---|---|
| | Mixing Ratio | | | Peeling | Retention |
| | SBRα | SBRβ | SBRγ | Strength | Rate (%) |
| Example 1 | 90 | 10 | — | 100 | 73 |
| Example 2 | 70 | 30 | — | 115 | 75 |
| Example 3 | 50 | 50 | — | 90 | 70 |
| Example 4 | 30 | 70 | — | 80 | 67 |
| Comparative Example 1 | 100 | — | — | 50 | 60 |
| Comparative Example 2 | — | 100 | — | 65 | 63 |
| Comparative Example 3 | — | 50 | 50 | 67 | 64 |

As can be seen from Table 1, the negative electrodes in Examples 1 to 4 had higher peeling strength of the negative electrode active material layer with respect to the negative electrode current collector than in Comparison Examples 1 to 3. In the test cells of Examples 1 to 4, the decrease in the capacity retention rate after the charge-discharge cycles was suppressed more. The negative electrode included in each of the test cells of Examples 1 to 4 contained the negative electrode active material composed of silicon-containing graphite particles, including graphite particles with voids and silicon-containing particles disposed in the voids, as well as the first binder that is styrene butadiene rubber with a glass-transition temperature of 1° C. or higher, and the second binder that is styrene butadiene rubber with a glass-transition temperature of lower than 1° C. As can be seen from the results in Table 1, this configuration was able to suppress the capacity decrease after the charge-discharge cycles.

The technology disclosed herein can encompass the technologies described in the following items.

### Item 1:

A negative electrode including:
a negative electrode active material comprising silicon-containing graphite particles including graphite particles with voids and silicon-containing particles disposed in the voids;
a first binder that is styrene butadiene rubber with a glass-transition temperature of 1° C. or higher; and
a second binder that is styrene butadiene rubber with a glass-transition temperature of lower than 1° C.

### Item 2:

The negative electrode according to Item 1, wherein a difference in glass-transition temperature between the first binder and the second binder is 5° C. or higher.

### Item 3:

The negative electrode according to Item 1 or 2, wherein a content of the first binder is greater than or equal to a content of the second binder.

### Item 4:

The negative electrode according to any one of Items 1 to 3, wherein the silicon-containing particle has a particle diameter of 1 μm or less.

### Item 5:

The negative electrode according to any one of Items 1 to 4, further comprising, as another negative electrode active material, graphite particles that are substantially free of silicon.

### Item 6:

An electricity storage device comprising the negative electrode according to any one of Items 1 to 5.

The above is a detailed description of the embodiments of the technology disclosed herein, but these are illustrative only and do not limit the scope of the claims. The technology described in the claims includes various modifications and changes of the specific examples illustrated above.

What is claimed is:

1. A negative electrode comprising:
a negative electrode active material comprising silicon-containing graphite particles including graphite particles with voids and silicon-containing particles disposed in the voids;
a first binder that is styrene butadiene rubber with a glass-transition temperature of 1° C. or higher; and
a second binder that is styrene butadiene rubber with a glass-transition temperature of lower than 1° C.

2. The negative electrode according to claim 1, wherein a difference in glass-transition temperature between the first binder and the second binder is 5° C. or higher.

3. The negative electrode according to claim 1, wherein a content of the first binder is greater than or equal to a content of the second binder.

4. The negative electrode according to claim 1, wherein the silicon-containing particle has a particle diameter of 1 μm or less.

5. The negative electrode according to claim 1, further comprising, as another negative electrode active material, graphite particles that are substantially free of silicon.

6. An electricity storage device comprising the negative electrode according to claim 1.
